(19) United States
(12) Patent Application Publication
(10) Pub. No.: US 2026/0169284 A1
(43) Pub. Date: Jun. 18, 2026

(54) LIGHT GUIDE ELEMENT, OBSERVATION OPTICAL SYSTEM, AND DISPLAY APPARATUS

(71) Applicant: CANON KABUSHIKI KAISHA, Tokyo (JP)

(72) Inventors: Ryo NOZAKI, Tokyo (JP); Keiichiro ISHIHARA, Saitama (JP)

(21) Appl. No.: 19/392,467

(22) Filed: Nov. 18, 2025

(30) Foreign Application Priority Data
Dec. 12, 2024 (JP) 2024-217696

(51) Int. Cl. G02B 27/00; G02B 27/01

(52) U.S. Cl. CPC G02B 27/0081; G02B 27/0172; G02B 2027/0178

(57) ABSTRACT

A light guide element may include a prism unit, an expander configured to expand a light beam diameter of light incident from the prism unit, and a light guide unit configured to guide the light expanded by the expander to an eyepoint. The expander has a first surface, a second surface, and a third surface that are parallel to a traveling direction of light that has entered the expander. The third surface is a partially transmissive reflective surface disposed between the first and second surfaces. The light that has entered the expander is reflected by a surface of the light guide element and the first and second surfaces.

### BACKGROUND

### Field of the Technology

The aspect of the disclosure relates to one or more embodiments of a light guide element, an observation optical system, and a display apparatus.

### Description of the Related Art

The conventional observation optical systems include a light guide plate that includes an expander configured to expand an image light beam diameter (U.S. Pat. No. 7,514,558 and PCT International Application Domestic Publication No. 2022-546979).

The configuration disclosed in U.S. Pat. No. 7,514,558 does not expand the light beam diameter in the direction orthogonal to the thickness direction of the light guide plate, and thus in a case where the image display element is longer in the direction orthogonal to the thickness direction to secure a wide eye motion box, the length of a projection optical system increases and the size of the observation optical system increases consequently.

The configuration disclosed in PCT International Application Domestic Publication No. 2022-546979 expands the light beam diameter in the thickness direction and the direction orthogonal to the thickness direction, but requires two projection optical systems and increases the size of the observation optical system.

### SUMMARY

One or more embodiments of a light guide element according to one or more aspects of the disclosure may a prism unit, an expander configured to expand a light beam diameter of light incident from the prism unit, and a light guide unit configured to guide the light expanded by the expander to an eyepoint. The expander has a first surface, a second surface, and a third surface that are parallel to a traveling direction of light that has entered the expander. The third surface is a partially transmissive reflective surface disposed between the first and second surfaces. The light that has entered the expander is reflected by a surface of the light guide element and the first and second surfaces. An observation optical system and a display apparatus each having the above light guide element also constitute another aspect of the disclosure.

Features of the disclosure will become apparent from the following description of embodiments with reference to the attached drawings. The following description of embodiments will be described by way of example.

### BRIEF DESCRIPTION OF THE DRAWINGS

FIG. 1 is a schematic diagram of a display apparatus according to a first embodiment.

FIGS. 2A, 2B, 2C, 2D, and 2E explain a light guide plate according to the first embodiment.

FIGS. 3A and 3B explain a light guide plate according to a second embodiment.

FIGS. 4A, 4B, 4C, and 4D explain a light guide plate according to a third embodiment.

FIGS. 5A, 5B, and 5C explain a light guide plate according to a fourth embodiment.

FIGS. 6A, 6B, 6C, and 6D explain a light guide plate according to a fifth embodiment.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

### First Embodiment

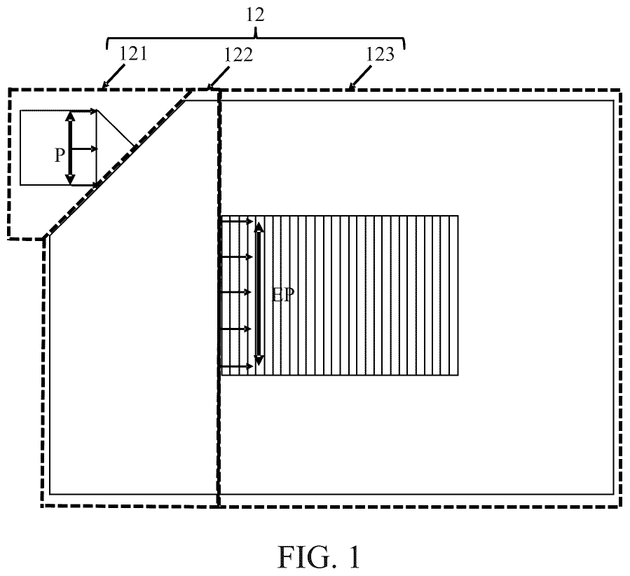

FIG. 1 is a schematic diagram of a display apparatus according to this embodiment, when viewed from the viewer's side. The display apparatus may be, for example, Augmented Reality (AR) glasses. The display apparatus includes a display element configured to display an image, and an observation optical system configured to guide an image light beam from the image to the viewer's (observer's) eye (eyepoint corresponding to the pupil of the viewer's eye). The observation optical system includes a projection optical system that is disposed in an unillustrated direction orthogonal to the plane of the drawing (the direction when viewed from the viewer's side, the line-of-sight (visual line) direction of the viewer), and a light guide plate (light guide element) 12 configured to guide an image light beam projected by the projection optical system to the eye. Here, the line-of-sight direction is a line-of-sight direction of the viewer when he views perpendicularly to the surface of the expander closest to the viewer.

The light guide plate 12 includes a prism unit 121 configured to cause the image light beam to travel within the light guide plate 12 while being internally reflected, an expander 122 configured to expand the incident image light beam, and an emitter (light guide unit) 123 configured to emit the expanded image light beam (expanded light beam) from the light guide plate 12 and guide it to the viewer's eye (eyepoint). For the light beam emitted from the light guide plate 12, the angle of the light beam in the width direction of the light guide plate 12 (direction orthogonal to the line of sight) serves as the vertical direction, and the angle of the light beam in the thickness direction (line-of-sight direction) of the light guide plate 12 serves as the horizontal direction.

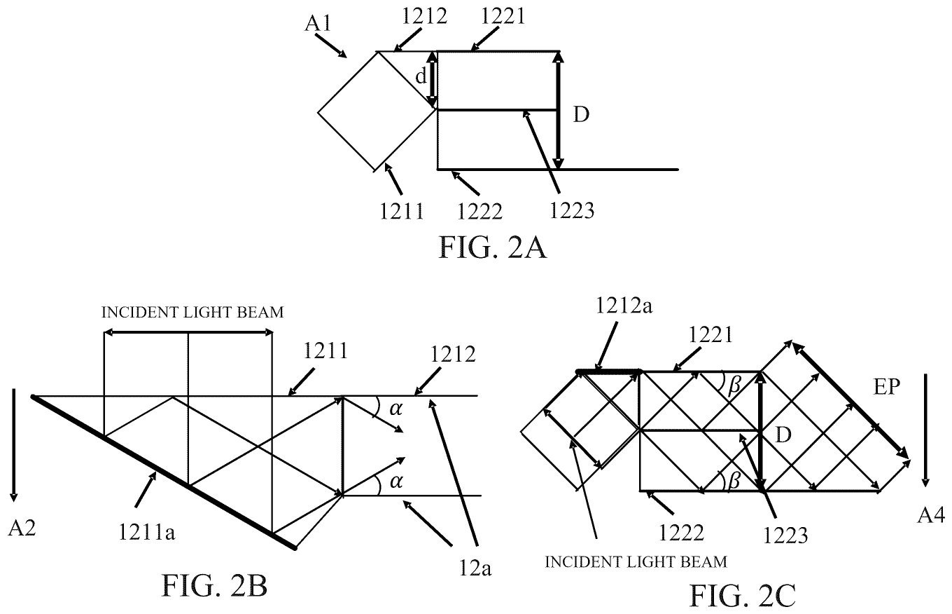

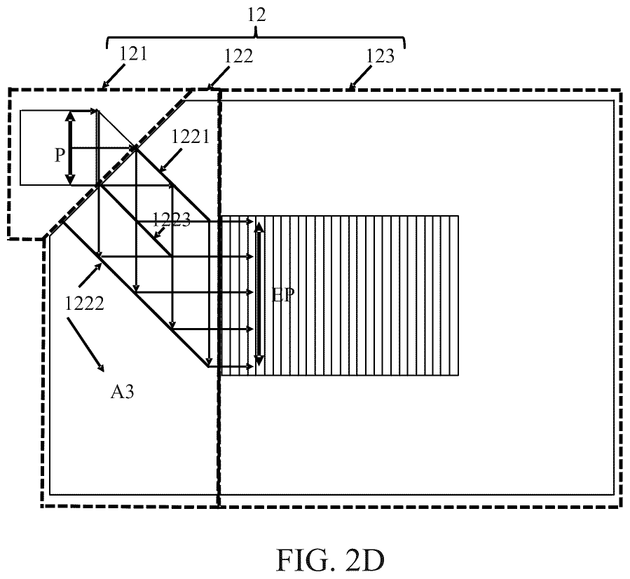

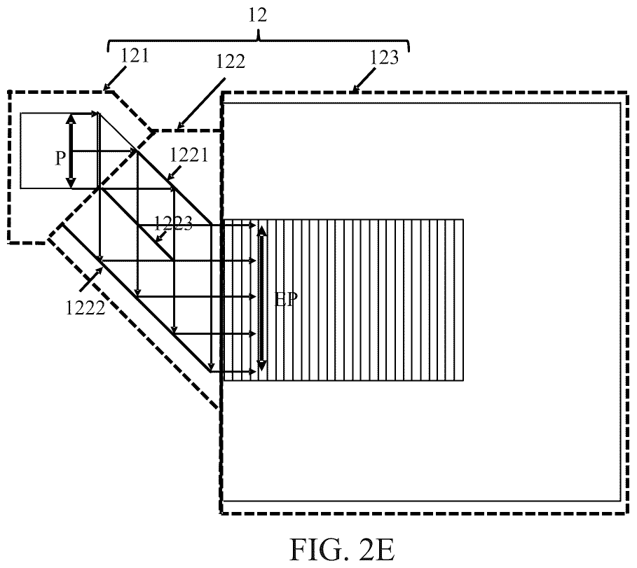

Referring now to FIGS. 2A, 2B, 2C, 2D, and 2E, a description will be given of the function and effect of the light guide plate 12 according to this embodiment. FIGS. 2A, 2B, 2C, 2D, and 2E explain the light guide plate 12 according to this embodiment. FIG. 2A illustrates the structure of the prism unit 121 and the expander 122. FIGS. 2B and 2C are schematic diagrams of the optical path of the image light beam. FIG. 2B is a view from the side indicated by arrow A1 in FIG. 2A. FIGS. 2D and 2E are schematic diagrams of the light guide plate 12.

The expander 122 has parallel reflective surfaces (first surface, second surface) 1221 and 1222, and partially transmissive reflective surfaces (partially transmissive reflective surface, third surface) 1223 arranged at a distance d that equally divides (or halves) the distance D between the reflective surfaces 1221 and 1222. Each reflective surface is orthogonal to the surface 12a of the light guide plate 12, which is an intersection plane with the line-of-sight direction of the viewer represented by arrow A2, and parallel to the traveling direction light incident on the expander 122 represented by arrow A3. The length of each reflective surface in the line-of-sight direction is the same as the thickness T of the light guide plate 12.

The reflective surface is a surface with the reflectance of 90% or higher. The reflective surface may be a surface with the reflectance of 95% or higher. On the other hand, the partially transmissive reflective surface is a surface with the reflectance lower than that of the reflective surface, i.e., a surface with the reflectance of less than 95%. The partially transmissive reflective surface may be a surface with the reflectance of 3% or higher and less than 90%. The partially transmissive reflective surface may be a surface with the reflectance of 5% or higher and less than 80%. The partially transmissive reflective surface may be configured so that at least a part of the surface is a transmissive reflective surface. Therefore, it may be configured so that only a part or whole of the surface is a transmissive reflective surface.

As illustrated in FIG. 2B, the prism unit 121 includes a first prism 1211 including a first structure 1211a that propagates a certain angle-of-view ray of the incident image light beam in the line-of-sight direction at an angle ±α. The first structure 1211a reflects light from the display element so that the light incident on the expander 122 travels while being reflected by the surface 12a of the light guide plate 12. The prism unit 121 further includes a second prism 1212 including second structure 1212a that causes, as illustrated in FIG. 2C, the light incident on the reflective surfaces 1221 and 1222 at angles ±β and incident on the expander 122 to have a light beam diameter of d in the arrangement direction of the respective reflective surfaces indicated by arrow A4. The second structure 1212a reflects light from the display element so that the light incident on the expander 122 propagates while being reflected by the reflective surfaces 1221 and 1222.

This structure can expand the light beam diameter P of the image light beam in the direction orthogonal to the line-of-sight direction to the light beam diameter EP, as illustrated in FIG. 2D.

Lengths L₁, L₂, and L₃ in the traveling direction of the light incident on the expander 122 of the reflective surfaces 1221 and 1222 and the partially transmissive reflective surface 1223, respectively, may satisfy the following inequality (1):

$${L}_{1} = {L}_{3} \geq \frac{D}{tan \vert β \vert} , {L}_{2} \geq \frac{2 D}{tan \vert β \vert} \qquad ( 1 )$$

The transmittance and reflectance of the partially transmissive reflective surface 1223 for the light from the display element may be both 50%.

Setting these lengths and characteristics can suppress the light intensity unevenness (or variations) of the expanded light beam.

In a case where the angle β is smaller than the critical angle of the light guide plate 12, at least one of the reflective surfaces 1221 and 1222 can be the outer surface of the light guide plate 12, as illustrated in FIG. 2E. By doing so, in applying the light guide plate 12 according to this embodiment to an eyeglass-type device, the expander 122 can be stored in the string, and the design performance can be improved.

As described above, the structure according to this embodiment can expand the light beam diameter in the line-of-sight direction and in the direction orthogonal to the line-of-sight direction inside the light guide plate 12, thereby achieving an observation optical system that can ensure a small and wide eye motion box.

### Second Embodiment

The basic structure of a display apparatus according to this embodiment is similar to that of the first embodiment. This embodiment will discuss only a difference from the first embodiment, and will omit the common components.

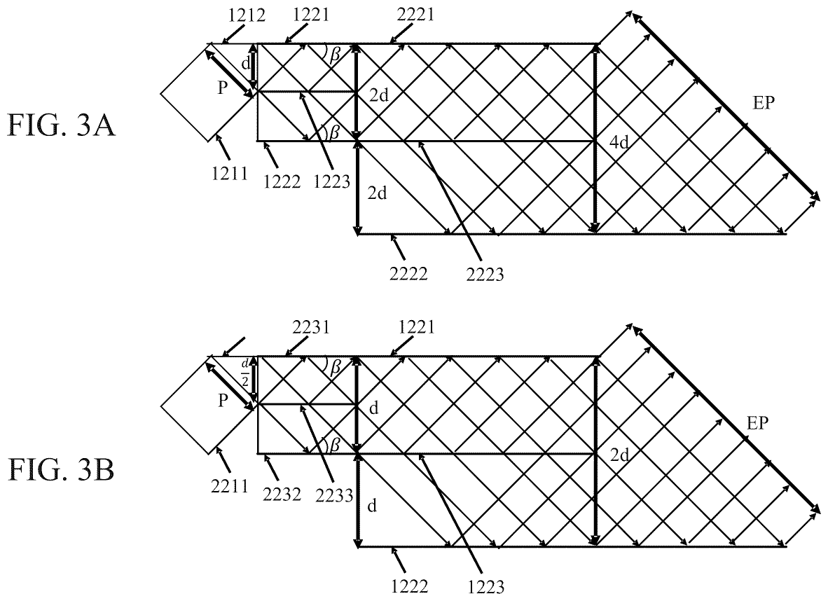

FIGS. 3A and 3B explain the light guide plate 12 according to this embodiment. The expander 122 has the structure of the first embodiment (first expander) and a configuration (second expander) including parallel reflective surfaces 2211 and 2212 and a partially transmissive reflective surface 2223 arranged at a distance of 2d, which equally divides a distance 4d between reflective surfaces 2221 and 2222. Consecutively arranging these two reflective surfaces and a configuration including a partially transmissive reflective surface can further expand the light beam diameter.

As illustrated in FIG. 3B, a structure including reflective surfaces 2231 and 2232 and a partially transmissive reflective surface 2233 arranged at a distance of d/2, which equally divides the distance d between reflective surfaces 2231 and 2232, may be disposed before the structure of the first embodiment. This structure can further reduce the light beam diameter P required to obtain the required beam diameter EP.

As described above, the structure according to this embodiment can achieve a larger beam diameter and a smaller projection optical system than those of the first embodiment.

In this embodiment, the two structures each having the two reflective surfaces and a partially transmissive reflective surface are consecutively arranged, but three or more such structures may be consecutively arranged.

### Third Embodiment

The basic configuration of the display apparatus according to this embodiment is similar to that of the first embodiment. This embodiment will discuss only the configuration that differs from that of the first embodiment, and will omit the common configuration.

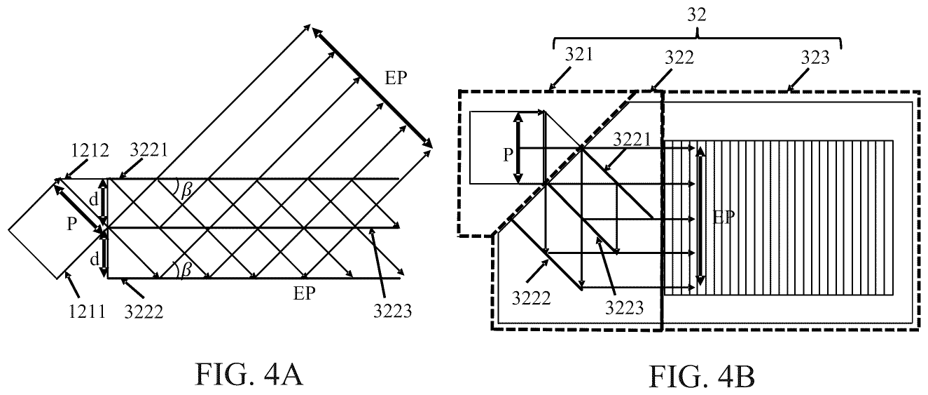

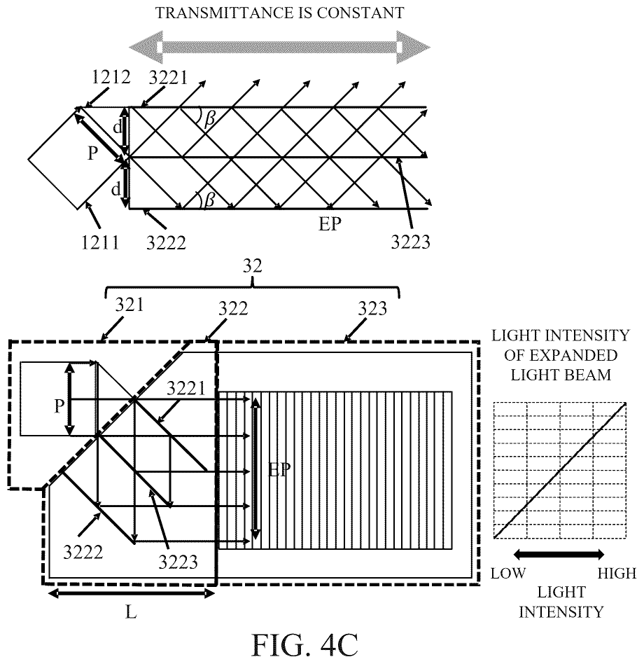

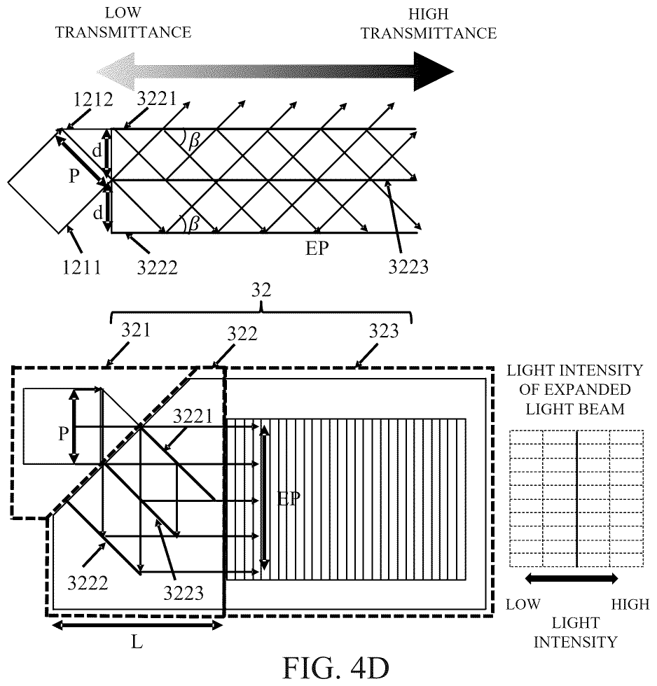

FIGS. 4A, 4B, 4C, and 4D explain a light guide plate 32 according to this embodiment. FIG. 4A is a schematic diagram of the optical path of the image light beam. FIG. 4B is a schematic diagram of the light guide plate 32. FIG. 4C illustrates the light intensity distribution of the expanded light beam when the transmittance of the partially transmissive reflective surface 3223 is constant. FIG. 4D illustrates the light intensity distribution of the expanded light beam when the transmittance of the partially transmissive reflective surface 3223 changes.

The light guide plate 32 includes a prism unit 321 that causes the image light beam to travel while being internally reflected within the light guide plate 32, an expander 322 configured to expand the incident image light beam, and an emitter 323 configured to emit the expanded image light beam from the light guide plate 12 and guide it to the eye.

The expander 322 has partially transmissive reflective surfaces 3221 and 3223, and a reflective surface 3222. The reflective surfaces are parallel and are spaced apart at a distance equal to the light beam diameter of the image light beam incident on the expander 322. The reflectance and transmittance of the partially transmissive reflective surface 3223 may be 50%. This structure can reduce the area of the expander 322 required to obtain the required beam diameter EP, as illustrated in FIG. 4B.

The reflectance of the partially transmissive reflective surface 3221 may be set so that the transmittance increases as a distance from the incident position on the expander 322 increases. In a case where the transmittance is constant, the light amount transmitting through the partially transmissive reflective surface 3221 decreases as the distance from the incident position increases, and the light intensity unevenness increases within the expanded light beam, as illustrated in FIG. 4C. On the other hand, in a case where the transmittance varies, the light intensity unevenness within the expanded light beam can be suppressed. The transmittance change can be achieved with a single type of coating, for example, by defining an area ratio between a mirror-coated portion and an uncoated portion on the reflective surface.

As described above, the structure according to this embodiment can expand the light beam diameter while reducing the area required for the expander.

### Fourth Embodiment

In the first to third embodiments, only the light beam diameter of the image light beam is expanded in the direction orthogonal to the line-of-sight direction. In this embodiment, the light beam diameter of the image light beam is also expanded in the line-of-sight direction. The basic configuration of the display apparatus according to this embodiment is similar to that of the first embodiment. This embodiment will discuss only the difference from the first embodiment, and will omit the common configuration.

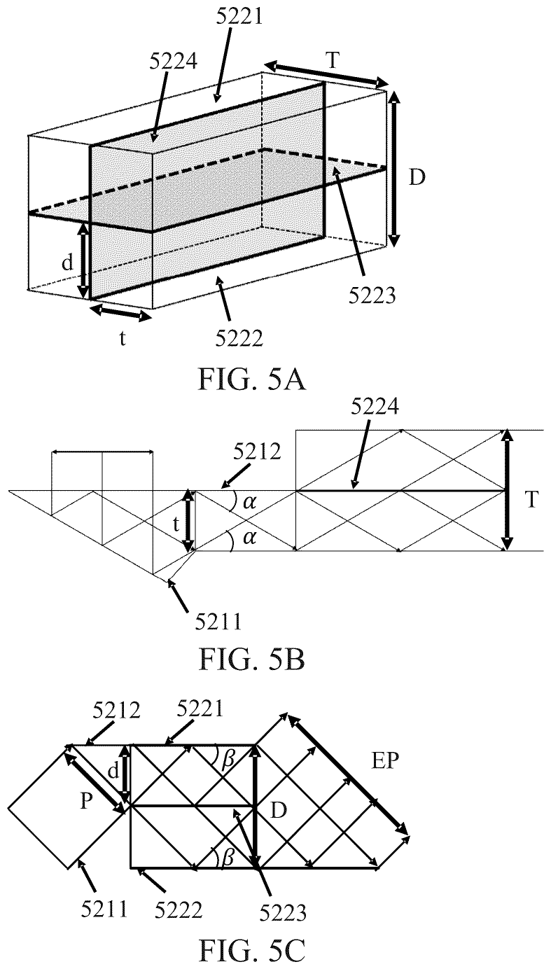

FIGS. 5A, 5B, and 5C explain the light guide plate 12 according to this embodiment. FIG. 5A is a perspective view of the expander according to this embodiment. FIGS. 5B and 5C are schematic diagrams of the optical path of the image light beam in this embodiment.

The expander 122 has parallel reflective surfaces 5221 and 5222, a partially transmissive reflective surface 5223 arranged at a distance d that equally divides the distance D between the reflective surfaces 5221 and 5222, and partially transmissive reflective surfaces (fourth surfaces) 5224 arranged at a distance t that equally divides the thickness T of light guide plate 12.

As illustrated in FIG. 5B, the prism unit 121 includes a first prism 5211 that propagates a certain angle-of-view ray of the incident image light beam toward the line-of-sight direction at an angle ±α. As illustrated in FIG. 5C, the prism unit 121 further includes a second prism 5212 that causes the light incident at an angle ±β on the reflective surfaces 5221 and 5222 and incident on the expander 122 to have a light beam diameter of d.

This structure can expand the light beam diameter of the image light beam in the line-of-sight direction, and thus reduce the light beam diameter required to fill the entire thickness of the light guide plate 12.

The lengths L₁, L₂, and L₃ in the traveling direction of the light incident on the expander 122 of the reflective surfaces 5221 and 5222 and the partially transmissive reflective surface 5223, and the length L₄ in the line-of-sight direction of the partially transmissive reflective surface 5224 may satisfy the following inequality (2):

$${L}_{1} = {L}_{3} \geq \frac{D}{tan \vert β \vert} , {L}_{2} \geq \frac{2 D}{tan \vert β \vert} , {L}_{4} \geq \frac{T}{tan \vert α \vert} \qquad ( 2 )$$

The transmittance and reflectance of the partially transmissive reflective surfaces 5223 and 5224 may be each 50%.

Setting these lengths and characteristics can reduce light intensity unevenness of the expanded light beam.

As described above, the structure according to this embodiment can expand the light beam two-dimensionally simultaneously within the light guide plate 12.

### Fifth Embodiment

The first to fourth embodiments assume that the width in the line-of-sight direction of the reflective surface of the expander is equal to the thickness of the light guide plate. This embodiment will discuss the structure of the expander in a case where the width of the reflective surface is narrower than the thickness of the light guide plate. This type of expander is applicable, for example, in a case where mirrors cannot be fully formed in the line-of-sight direction due to the manufacturing constraints.

The basic configuration of the display apparatus according to this embodiment is similar to that of the first embodiment. This embodiment will discuss only the configuration that differs from that of the first embodiment, and will omit a description of the common configuration.

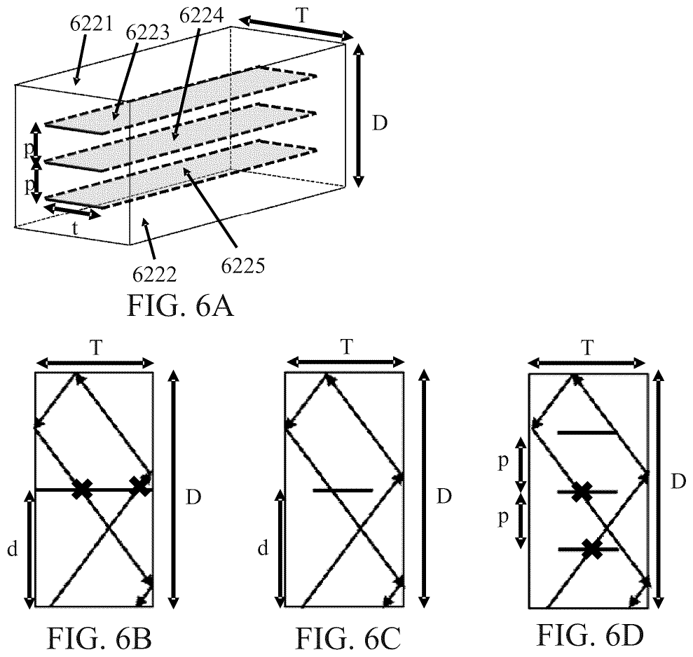

FIGS. 6A, 6B, 6C, and 6D explain the light guide plate 12 according to this embodiment. FIG. 6A is a perspective view of the expander 122.

The expander 122 includes parallel reflective surfaces 6221 and 6222 and a plurality of partially transmissive reflective surfaces 6223, 6224, and 6225 arranged at a distance p that equally divide the distance D between the reflective surfaces 6221 and 6222. The width t of the partially transmissive reflective surfaces 6223, 6224, and 6225 in the line-of-sight direction is narrower than the thickness T of the light guide plate 12. At this time, a distance p between two adjacent partially reflective mirrors may satisfy the following equation (3) using the distance d in the first embodiment:

$$p = \frac{t}{T} d \qquad ( 3 )$$

FIG. 6B illustrates the optical path of a light ray incident on the expander 122 in the first embodiment, when viewed from the prism unit 121 side. FIGS. 6C and 6D illustrate the optical path of a light ray incident on the expander 122 in this embodiment and traveling the same distance as that of the light ray in FIG. 5B, when viewed from the prism unit 121 side. FIG. 6C illustrates the case where p=d, and FIG. 6D illustrates the case where p=(t×d)/T.

In a case where equation (3) is not satisfied, as in FIG. 6C, the number of reflections on the partially transmissive reflective surface is fewer than that in a case where the width of the partially transmissive reflective surface is equal to the thickness T of the light guide plate 12. In such a case, the light amount in the area that would originally reflect and expand the light beam is reduced, and the expanded light beam may have light amount unevenness. On the other hand, when equation (3) is satisfied, as in FIG. 6D, all light rays are reflected at least the same number of times as that in a case where the width of the partially transmissive reflective surface is equal to the thickness T of the light guide plate 12, and thereby the light amount unevenness in the expanded light beam can be suppressed. Thus, even in a case where the width of the partially transmissive reflective surface is narrower in the line-of-sight direction, reducing the distance between the partially transmissive reflective surfaces can expand the light beam while suppressing the light amount unevenness in the expanded light beam.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each embodiment can provide a light guide element for an observation optical system that can ensure a small and wide eye motion box.

This application claims the benefit of Japanese Patent Application No. 2024-217696, which was filed on Dec. 12, 2024, and which is hereby incorporated by reference herein in its entirety.

What is claimed is:

1. A light guide element comprising:
a prism unit;
an expander configured to expand a light beam diameter of light incident from the prism unit; and
a light guide unit configured to guide the light expanded by the expander to an eyepoint,
wherein the expander has a first surface, a second surface, and a third surface that are parallel to a traveling direction of light that has entered the expander,
wherein the third surface is a partially transmissive reflective surface disposed between the first and second surfaces, and
wherein the light that has entered the expander is reflected by a surface of the light guide element and the first and second surfaces.

2. The light guide element according to claim 1, wherein the prism unit includes:
a first prism including a first structure that reflects the light so that the light incident on the expander is reflected on the surface of the light guide element, and
a second prism including a second structure that reflects the light so that the light incident on the expander is reflected at the first and second surfaces.

3. The light guide element according to claim 1, wherein the following inequalities are satisfied:
$${L}_{1} \geq \frac{D}{tan \vert β \vert}$$
$${L}_{2} \geq \frac{2 D}{tan \vert β \vert}$$
$${L}_{3} \geq \frac{D}{tan \vert β \vert}$$
where L₁, L₂, and L₃ are lengths of the first to third surfaces in the traveling direction, D is a distance between the first and second surfaces, and B is an angle at which the light incident on the expander enters the first and second surfaces.

4. The light guide element according to claim 1, wherein a transmittance and a reflectance of the third surface for the light are each 50%.

5. The light guide element according to claim 1, wherein the third surface is disposed at equal distances from the first and second surfaces, and
wherein a distance between the first and third surfaces is equal to a light beam diameter of the light incident on the expander in an arrangement direction of the first to third surfaces.

6. The light guide element according to claim 5, wherein the expander includes a first expander and a second expander which light from the first expander is to enter, and
wherein a distance between third surfaces of the first and second expanders is equal to a light beam diameter of light incident on the second expander in the arrangement direction.

7. The light guide element according to claim 1, wherein one of the first and second surfaces is a partially transmissive reflective surface.

8. The light guide element according to claim 1, wherein the expander has a fourth surface that is parallel to the surface of the light guide element and is a partially transmissive reflective surface.

9. The light guide element according to claim 8, wherein the prism unit reflects the light so that the light incident on the expander is reflected on the surface of the light guide element, and
wherein the following inequality is satisfied:
$${L}_{4} \geq \frac{T}{tan \vert α \vert}$$
where L4 is a length of the fourth surface in a line-of-sight direction, T is a length of the light guide element in the line-of-sight direction, and a is an angle at which the light is incident on the surface of the light guide element.

10. The light guide element according to claim 1, wherein the third surface is shorter than the light guide element in a line-of-sight direction.

11. The light guide element according to claim 10, wherein a plurality of third surfaces are provided, and
wherein the following equation is satisfied:
$$p = \frac{t}{T} d$$
where p is a distance between two adjacent third surfaces, t is a length of the third surface in the line-of-sight direction, T is a length of the light guide element in the line-of-sight direction, and d is a light beam diameter of the light incident on the expander in an arrangement direction of the first to third surfaces.

12. An observation optical system comprising:
a light guide element; and
a projection optical system configured to project light onto the light guide element,
wherein the light guide element includes:
a prism unit,
an expander configured to expand a light beam diameter of light incident from the prism unit, and
a light guide unit configured to guide the light expanded by the expander to an eyepoint,
wherein the expander has a first surface, a second surface, and a third surface that are parallel to a traveling direction of light that has entered the expander,
wherein the third surface is a partially transmissive reflective surface disposed between the first and second surfaces, and
wherein the light that has entered the expander is reflected by a surface of the light guide element and the first and second surfaces.

13. A display apparatus comprising:
an observation optical system; and
a display element,
wherein the observation optical system includes:
a light guide element, and
a projection optical system configured to project light from the display element onto the light guide element,
wherein the light guide element includes:
a prism unit,
an expander configured to expand a light beam diameter of light incident from the prism unit, and
a light guide unit configured to guide the light expanded by the expander to an eyepoint,
wherein the expander has a first surface, a second surface, and a third surface that are parallel to a traveling direction of light that has entered the expander,
wherein the third surface is a partially transmissive reflective surface disposed between the first and second surfaces, and
wherein the light that has entered the expander is reflected by a surface of the light guide element and the first and second surfaces.
